(19) United States
(12) Patent Application Publication
(10) Pub. No.: US 2016/0027330 A1
(43) Pub. Date: Jan. 28, 2016

(54) FOOD MANAGEMENT SERVICES

(71) Applicant: Kitchology Inc., Wilmington, DE (US)

(72) Inventors: Alain C. Briancon, Poolesville, MD (US); Iris S. Sherman, Kennebunk, ME (US); Michele A. Drgon, Stuart, FL (US); Chris A. Giacoponello, Pottstown, PA (US); Ellen S. Foreman, State College, PA (US); Howard E. Goldberg, Wynnewood, PA (US); Marc D. Feldman, Kennebunkport, ME (US); Ian T. Durham, Kennebunk, ME (US)

(73) Assignee: KITCHOLOGY INC., Wilmington, DE (US)

(21) Appl. No.: 14/878,646

(22) Filed: Oct. 8, 2015

Related U.S. Application Data
(63) Continuation-in-part of application No. 13/730,265, filed on Dec. 28, 2012.
(60) Provisional application No. 61/581,934, filed on Dec. 30, 2011.

(51) Int. Cl. G09B 19/00; G06F 17/30

(52) U.S. Cl. CPC G09B 19/0092; G06F 17/30876; G06F 17/30699

(57) ABSTRACT

A computer-implemented method includes identifying recipes and receiving a grade selection, from each user of a food management system, for each of the recipes. An average grade for the recipes is calculated based on the grade selection received from each of the users. One of the users is identified from whom a grade selection was received that is greater than the average grade. The grade selection received from the identified user is correlated with the grades received from the other users. At least one of the other users whose grades most closely correlate with the grade given to the group of recipes by the identified user is identified. One or more recipes are provided to the identified one of the users that the identified one of the users has not graded based on grades given to the recommended recipe by the identified at least one of the other users.

### CROSS REFERENCE TO RELATED APPLICATION

This application is a continuation-in-part of U.S. patent application Ser. No. 13/730,265, which claims the benefit of U.S. provisional application No. 61/581,934, filed Dec. 30, 2011, which is incorporated herein by reference as if fully set forth.

### BACKGROUND

Many consumers need to comply with some level of food restriction as a result of medical conditions. In the US only, food allergies affect 14 million households; food intolerance 30 million; Celiac/Coeliac 4 million; Asthma 26 million; and autoimmune and diabetes 47 million households. These restrictions impact the quality of life and joy associated with food activities, such as shopping, selecting recipes, cooking, and even eating food, by creating barriers to unrestricted shopping choices. For example, people with medically-necessitated food restrictions may be forced to engage in careful analysis of ingredients of food from food labels, resulting in longer shopping trips, and to restructure recipes to accommodate different members of the household. This may result in a substantial reduction in the pleasure that people derive from eating food and a marked increase in stress.

In addition to medically-necessitated diet restrictions, many consumers focus on sustainability issues such as shopping for organic, local, and/or chemical free foods, or more efficient consumption and reduced food waste. And many consumers express preferences, such as having a non-medical preference for a no starch diet, but may not consistently follow their preferences because of the difficulty associated with doing so.

For both types of consumers, the ability to screen their food activities in an efficient, adaptive manner is critical.

### SUMMARY

A computer-implemented method and a system are described. A computer-implemented method of recommending recipes to a user of a food management system may include identifying a group of recipes from among a plurality of recipes in a database and receiving a grade selection, from each of a plurality of users of the food management system, for each of the recipes in the identified group. An average grade for the group of recipes may be calculated based on the grade selection received from each of the plurality of users of the food management system. One of the plurality of users of the food management system may be identified from whom a grade selection was received that is greater than the average grade for the group of recipes. The grade selection received from the identified one of the plurality of users for the group of recipes may be correlated with the grades received from the other users of the plurality users for the same group of recipes. At least one of the other users whose grades most closely correlate with the grade given to the group of recipes by the identified user may be identified. And one or more recipes in the database may be provided to the identified one of the plurality of users that the identified one of the plurality of users has not graded based on grades given to the recommended recipe by the identified at least one of the other users.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments that are presently preferred. It is understood, however, that the invention is not limited to the precise arrangements and instrumentalities shown.

FIG. 1A is a flow diagram of an example computer-implemented method of recommending recipes to a user of a food management system.

FIG. 1B illustrates a user specified kitchen diary that may be accessible on a PC, tablet, or mobile phone.

FIG. 2 is a diagram of a personal food assistant operating within a smart phone coordinating with a consumer kitchen diary, along with a kitchen diaries analysis computer (KDAC) performing analysis on the food activity media objects (FAMOs) stored in their respective kitchen diaries to provide services.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. As used herein, “connected” means that elements within the system are connected physically or through a remote connection such that they are functionally connected. This connection can be temporary or permanent. As a non-limiting example, a remote connection may be through a localized Radio Frequency link. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

Embodiments include a system and methods for managing, supporting and empowering consumers to manage their food experience in an enhanced manner to achieve as many of their sometimes concurrent, and sometimes overlapping, objectives as possible, while living within the limits of medically, culturally or life-style imposed restrictions. The present application remedies the shortcomings of the prior art by enabling consumers to control key elements of their overall food procurement and consumption experience while maintaining privacy over their actions and controlling how third parties share and utilize their personal, food-related information. This allows the development of specialized websites and mobile applications, thereby allowing a much greater expression of intimacy and relevance for the consumer, and creating a more focused market target for service providers.

Embodiments include a method of providing food management services. Food management services may collectively include one or more of food tracking, food budgeting, diet compliance, shopping choices, access to third parties, and/or waste services. The method for providing food management services may include offering one or more incentives for prospective consumers to register with a provider of food management services, receiving a request at the provider of food management services from a consumer to register with the provider of food management services to receive at least one of the offered incentives, registering the consumer with the food management provider of services, assigning a unique identifier to the registered consumer, assigning permission granted to one or more recording devices of the registered consumer that is connected to a network to record food activities of the registered consumer using the unique identifier at the provider of food management services, enabling one or more applications on said registered consumer's recording device to generate unique transaction identifiers to record food activity information of the registered consumer, generating food activity media objects (FAMOs) on said recording devices with granted permissions or recording devices of associated consumers with allowed permissions, receiving, at the provider of food management services, FAMOs from one or more of the registered consumer's recording devices, recording at the provider of food management services, of at least part of the FAMOs as associated with the unique identifier, communicating receipt of FAMOs from the provider of food management services to one or more of the registered consumer's recording device or recording devices of associated consumers, and generating a database, by the provider of food management services, of individual, and aggregated consumer activity, wherein the individual consumer activity includes the FAMOs that are recorded.

The method may also include receiving, at the provider of food management services, FAMOs from one or more additional registered consumer's recording devices prior to the step of recording at least part of the FAMOs associated with the unique identifier.

FAMOs may be generated by events including, but not limited to, consumer interaction, interaction with experts, referral generation, referral management, package scanning, picture taking, audio recording, video recording, item scanning, nutrient checking, caloric ratio estimation, estimated glycemic load/index computation, search for recipe, modification of recipe, response to query from food providers, response to query from food service management services providers, advice from independent agents, advice from agents affiliated with food management service providers, advice from agents registered with food management service provider, expiration of a timer, date of food activities, reading of referrals, generation of referrals, location of food activities, food ratings, rating of recipes, and rating of food activities. FAMOs may include offers of third parties to registered consumers and the possible disposition thereof. The possible disposition includes, but is not limited to, acceptance, rejection, acknowledgment of receipt, forwarding of, sharing, posting on a social network, inclusion in a blog, inclusion in a wiki, assigning a like/dislike, assigning a tag, assigning a hashtag, assigning a metatag, inclusion in an activity timeline, and inclusion in a list.

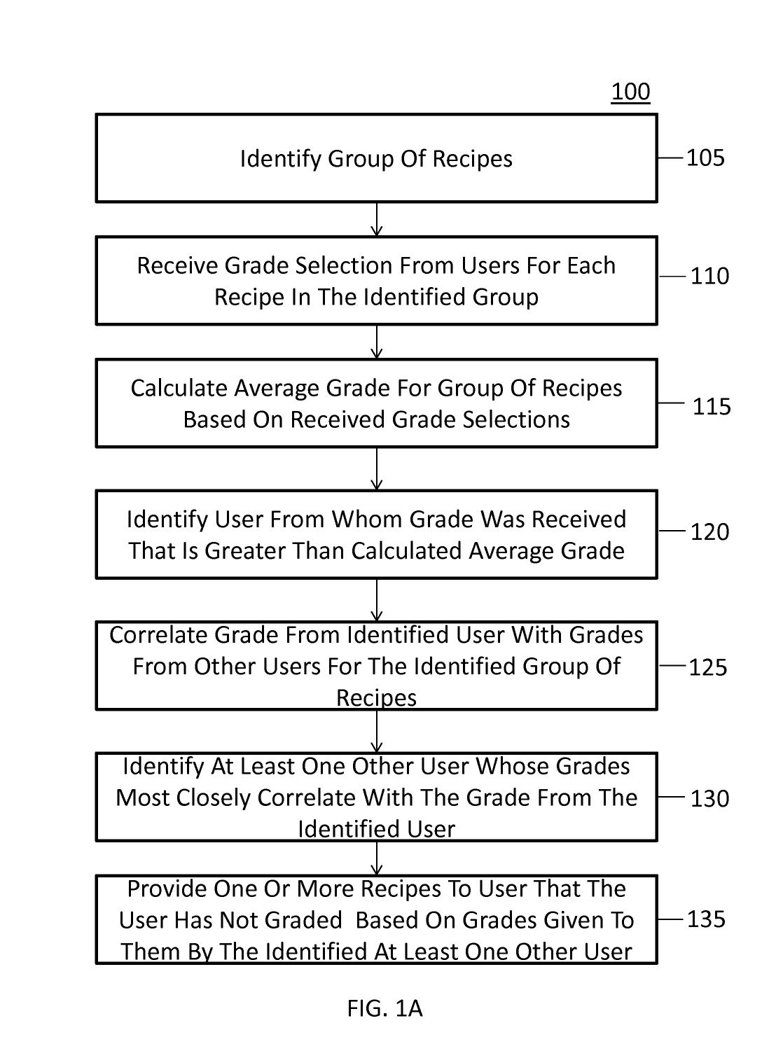

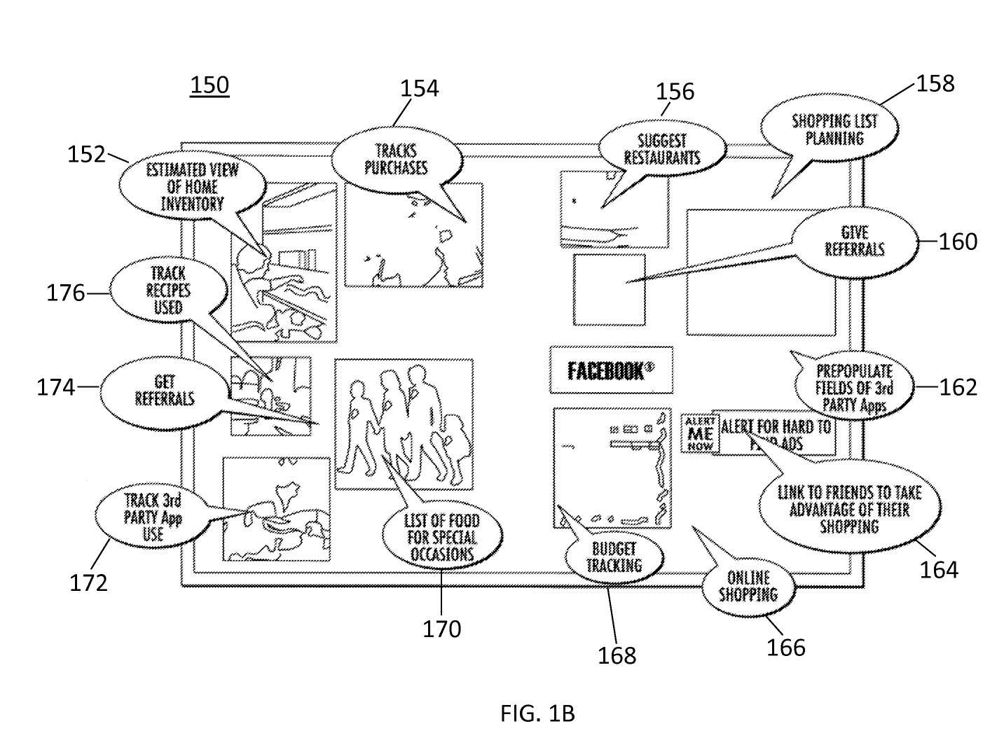

FIG. 1 is a flow diagram of an example computer implemented method 100 of recommending recipes to a user of a food management system. In the example method illustrated in FIG. 1, a group of recipes may be identified from among a plurality of recipes in a database (105). In an embodiment, the group of recipes may be referred to as a set of common food activities (SCFA). Examples of other SCFAs may be, in addition to or in lieu of the group of recipes, alterations to recipes in the database, shopping lists, or restaurants/menu offerings.

The method 100 may also include receiving a grade selection, from each of a plurality of users of the food management system, for each of the recipes in the identified group (110). In an embodiment, a user may be presented with a grading scale (e.g., 0-10, 10 being the best tasting recipe and 0 being the worst tasting recipe), and the user may select a grade from among the grades on the scale. In an embodiment, the selectable grades may be displayed on a display, and the user may make a grade selection by clicking on one of the displayed grade options. In some embodiments, the grade may be automatically selected by the food management system (e.g., if an ingredient in a recipe is excluded for the user for some reason).

In some embodiments, the grading may be more complex than simply grading the overall taste of a recipe. For example, various aspects of the recipes may be individually graded, such as cuisine type (e.g., Indian, vegetarian, or low salt), cooking approach (e.g., slow cooker, grilling, or 5 minute or less preparation time) or ingredients. In one such embodiment, the grading scale presented may include a 0 or 1 scale. For example, if a user is highly allergic to some substance, their grade of any SCFA that includes that ingredient may be set to 0. Or if the user insists that some ingredient be included in any recommendation, their grade of any SCFA that includes that ingredient may be set to 1. This approach includes inclusion or exclusion from a set of acceptable states. For another example, a user may select from a list or enter some imprecise term to describe at least one aspect of an SCFA, such as spicy, salty, or savory with one or more modifiers, such as more or less. Fuzzy logic may then be applied to the user input, resulting in a mathematical grade being generated for the SCFA based on the user input.

Between the extremes of inclusion/exclusion and use of imprecise terms, there may be ranges of numerical values that may be applied in linear or non-linear relationships. For example, spiciness may be assigned a range of 0 to 10, with 0 being no spiciness and 10 being the highest level of spiciness. For another example, an aspect of an SCFA, such as spiciness, may be quantified by quantifying the result via some measurement that is not subject to human subjective ratings. For example, the Scoville Scale for rating spiciness of peppers may be used to quantify the spiciness a user experiences upon tasting food prepared based on a particular recipe. Using the Scoville Scale, for example, a specific weight of peppers is processed to extract the capsinoids. Depending on what dilution is needed for a panel of experts to detect the spice, a value may be assigned. In an embodiment, grading may be based on visual appeal of the recipe (e.g., a user rates a picture of a prepared recipe based on its visual appeal on a provided scale, such as 0 to 10).

The potential grading methods described above are at least somewhat subjective. Often, the ratings among users will vary significantly. In general, the relationships between the values may be more accurate than any particular numbers assigned.

In embodiments, the grade of an SCFA may be a function of a number of different attributes, such as input user grades, consumer ratings, number of referrals, number of likes, number of uses, number of purchases, proportion of purchases, food restrictions, ingredient restrictions, compliance with religious regulations, organic nature, processing restrictions, brand restrictions and/or country of origin restrictions. In such embodiments, the food management system may determine a grade for an SCFA by assigning weights to the different attributes and averaging each attribute for a particular group.

Referring back to FIG. 1, the method 100 may further include calculating an average grade for the group of recipes based on the grade selection received from each of the plurality of users of the food management system (115). The average grade may be referred to as an aggregation minimum grade threshold (AMGT). One of the plurality of users of the food management system may be identified, from whom a grade selection was received that is greater than the average grade for the group of recipes (120). The grade selection received from the identified one of the plurality of users for the group of recipes may be compared with the grades received from the other users of the plurality of users for the same group of recipes (125). At least one of the other users whose grades most closely correlate with the grade given to the group of recipes by the identified user may be identified (130). One or more recipes in the database may be provided to the identified one of the plurality of users that the identified one of the plurality of users has not graded based on grades given to the recommended recipe by the identified at least one of the other users (135).

Grades may be compared by various means, which may vary depending on the nature of the attribute being graded, if applicable. For example, standard correlation or distance correlation may be used. Correlation is a statistical relationship, and, as such, the more data points that are available the more accurate the determined correlation will be. In the embodiments described herein, the grades may be functions of the data points, which may have relationships to characteristics of the recipes. An individual's correlation to a subset of the population's data points may be calculated by determining a correlation coefficient ρx,y between two random variables X and Y with expected values μx and μy and standard deviations σx and σy, which may be defined by:

$${ρ}_{X , Y} = corr ( X , Y ) = \frac{cov ( X , Y )}{{σ}_{X} {σ}_{Y}} = \frac{E [ ( X - {μ}_{X} ) ( Y - {μ}_{Y} ) ]}{{σ}_{X} {σ}_{Y}} , \qquad ( Eq . 1 )$$

where E is the expected value operator, coy stands for covariance, and corr is a widely used alternative notation for the correlation coefficient. Given a user's data points compared to other individual's data points, their mutual correlation may be determined. The closer the calculated correlation is to 1, the more likely that the changes perceived by a user will also be perceived in the same fashion by an identified user.

For distance correlation, grades may be thought of as values assigned to the various dimensions of a vector. The squared sample distance covariance may be the arithmetic average of the products A_{j, k} B_{j, k}:

$${dGov}_{n}^{2} ( X , Y ) := \frac{1}{{n}^{2}} {\sum }_{j , k = 1}^{n} {A}_{j , k} {B}_{j , k} .$$

The closer the distance covariance is to 1, the more closely the vectors may be, and, in the embodiments described herein, the user's relationship to a recipe or other SCFA selection.

For example, in some of the examples described above with respect to FIG. 1, each user may have one or more grading values assigned to the various aspects of one or more recipes. In the above equation, these grading values may translate into the Aj,k variables for one user and Bj,k variables for another. In some embodiments, either or both of the variables may refer to some mathematical consolidation of a group (e.g., profile shows like of Italian food) of users grades (e.g., average value, mean value). The closer the calculated correlation is to 1, the more likely both users, or the group consolidation, will have the same gradings. If some grading is not provided for one user (e.g., no expressed grade is provided for an ingredient), the missing grading may be speculated based on the correlation number between the users or user groups and the value for the ingredient assigned by the other user.

As time progresses, the robustness of the food management system may be enhanced by users providing feedback, such as on recipes they have tried, menu items they have eaten, etc., so that the database may be refined. As users provide more information to the food management system, more data points may be available for use in correlating user gradings, which may lead to more accurately predicted relationships.

In an embodiment, recommendations may be made based on a user's identity with a particular group. For example, an AMGT may be calculated for different recipes based on how a defined group grades the recipes (e.g., a vegetarian group, cuisine preference, a low salt group, etc.). Recipe recommendations may be made to a particular user based on their identification with one or more groups and the AMGT.

As described above, SCFAs may include food activities other than recipes. For example, a user whose grading of an SCFA closely correlates with the grading of the SCFA by one or more other users may be likely to enjoy the same modifications to recipes as the closely correlated users. Such alterations of recipes may be for accommodating specific food goals of a user, such as vegetarian substitutions, allergy-based substitutions, or low-calorie substitutions, or based on available inventory (e.g., a user is not willing to do additional shopping so a recipe is altered based on the ingredients a user indicates he or she has on hand). If there is no exact match, under some circumstances a user's mandatory profile requirements (e.g., allergic to peanuts) may need to take precedence when recommending substitutions.

For another example, grading correlation may be used to recommend menu items that a user may enjoy at a restaurant. In an embodiment, restaurants may provide information to the food management system (e.g., via WiFi, the Internet or Bluetooth), such as information regarding the recipes used to make their foods, ingredient listings, etc. The food management system may use this information to provide recommendations to users on foods that may meet their food goals and may also provide nutritional information on the menu items to further augment the analysis of the available recipes. Any information gathered from the restaurant could also be added to the database for future utilization. For example, a user could indicate that they intend to eat out and, based on their profile and immediate situation (e.g., location or food preference), a restaurant may be identified as meeting or not meeting their needs.

In an embodiment, a user may also enter consumer-specific information into the food management system. Such consumer-specific information may include, for example, one or more of a diet restriction, a food restriction, an ingredient restriction, an additive restriction, a diet framework, a diet plan, a food selection restriction, a food preference, cross-contamination information, a budgetary guideline, or a loyalty program. The one or more recipes in the database may be provided to the identified one of the plurality of users based on both the grades given to the recommended recipe by the identified at least one of the other users and the received at least one piece of consumer-specific information. In an embodiment, consumer-specific information may also include restrictions on the use of information provided to the food management system by the user. Consumer-specific information may be entered into the food management system, for example, when a user registers for an account or at any other time that the information becomes relevant for a particular user's food choices.

In an embodiment, a user may enter consumer-specific information when he seeks a recommendation for a recipe. In such an embodiment, a consumer may indicate, for example, whether he is willing to shop for ingredients or what ingredients he has on hand, and recommendations may be limited or expanded based on the user's indication. A user may also enter specific nutritional needs. The food management system may obtain information about ingredients in the recipe and may calculate the overall compliance of a recipe with the entered nutritional needs. In an embodiment, a user may specify a maximum number of calories he wishes to consume in a meal, and the food management system may analyze the number of calories in the recipes it recommends to make sure the recommendations comply with the user's desired calorie count, alter recipes to meet the user's calorie requirements or analyze the number of calories a user has consumed in all of the recommended recipes over a period of time.

In an embodiment, the consumer manages his food activities using a kitchen diary that integrates input from multiple sources and activities. FIG. 1B illustrates an example graphic user interface (GUI) 150 for an example kitchen diary. The example GUI 150 illustrated in FIG. 1B provides a number of different regions where a user can either click or enter information to engage in various food management activities or in which food-management-related-information may be displayed. For example, a user may manage his food inventory by, for example, listing ingredients he has on hand, indicating whether he is willing to shop for ingredients, or receive recommendations for ingredients to shop for based, for example, on indicated allergies, indicated likes, indicated nutritional requirements, an indicated diet, or ingredients required for particular selected or recommended recipes (152). A user may track purchases (154). And a user may receive or make restaurant, or menu item, recommendations for particular restaurants, as described above (156).

A user may plan a shopping list (158) using the GUI 150. For example, software operating on the kitchen diary data allows the estimation of the current food levels of key foodstuff (i.e., based on information tracked (152)). This can then be turned into a shopping list (158) or to prepopulate third party applications (162) that assist consumers when shopping, providing filters for “healthy” foods, managing food restrictions, ingredient restrictions, compliance with religious regulations, organic nature, processing restrictions, brand restrictions, and country of origin restrictions. A user may also give referrals (160).

With regard to pre-populating fields of a third party application (162), mobile applications are, for example, integrated with the kitchen diary by providing the facility to prepopulate key fields and report activity and data activity back to the kitchen diary. For another example, the consumer uses a smartphone with a smartphone application providing the linkage and intelligence to act as his or her personal food assistant to channel multiple aspects of the food activities compliant with goals and restrictions.

Using the GUI 150, a user may link to other users to gain information based on their shopping experiences (164). Further, a user may engage in online shopping (166), for example, based on provided recommendations. Here, users may be automatically linked to websites, or provided with recommended sellers, based on recommendations provided via the food management system.

A user may use the GUI 150 for food-related budgeting purposes (168). For example, amounts paid for previous shopping trips may be tracked, so a user may keep track of how much he is spending on food. Recommendations on saving money on future shopping trips may also be provided, such as by providing information on sales or available coupons on items that a user has purchased in the past or that are recommended for the user to purchase based on inclusion in a recommended recipe, for example. For another example, the kitchen diary keeps track of past expenses, assists in budgeting for future expenses, and filters according to store, food type, rebate levels, offers, amount purchases, and preferences.

Foods for special occasions may also be listed using the GUI 150 (170). For example, food that is special to specific members of the family may be tracked and used to trigger reminders for purchasing them on special occasions, such as birthdays, etc. These reminders can be performed while on the go.

A region of GUI 150 may be reserved for tracking third party application use (172), and other regions may be used for a user to get referrals (174), such as for recipes, as described above, and to track recipes that the user has used (176). For example, a user may input grading information for recipes he has used, and the food management system may track the recipes that have been recommended to a user versus the ones the user has indicated he has used.

In an embodiment, a kitchen diary may capture shopping information using, for instance, the XML based digital receipt structure of the Association for Retail Technology Standards, or using database-to-database transfers. It may also be obtained through information entered by scanning of shopping receipts and performing optical character recognition of items followed by insertion of simple descriptions. Capturing recipes from the web is also provided, along with the ability to change them according to consumer choices. An important source of data about food activity is captured when the consumer scans specific food items, whether for nutritional content, seeking pricing information, asking for a coupon/discount, or seeking a recipe.

In another embodiment, the consumer sets and manages a series of food goals that are quantifiable performance measures using the kitchen diary. These include, but are not limited to, calorie intake, calories distributed among fat and non-fat products, amount of salt consumed, number of times take-out food is ordered, amount of food being wasted, or budget allocated to food or specific stores.

In one embodiment, the kitchen diary comprises software running on a computer. In another embodiment, the kitchen diary is hosted by a remote computer, such as existing in cloud computing (e.g., Internet accessible computer resources). In either case, the kitchen diary can synchronize and communicate with a smartphone, for example, using applications running on the smartphone.

In another embodiment, the consumer enters preferences and restrictions, such as diets, ingredients to filter reports and/or queries.

In another embodiment, changes in the consumer activities are detected to propose new services or new foods. To facilitate the exchange of information and allow a distributed promotional system, information may be encoded in a manner that allows data encapsulation. Methods from web 2.0 (such as, but not limited to, JSON, JSONP, JSON-RPC, SOAP, REST, XML-RPC) can readily be used to create these Food Activity Media Objects.

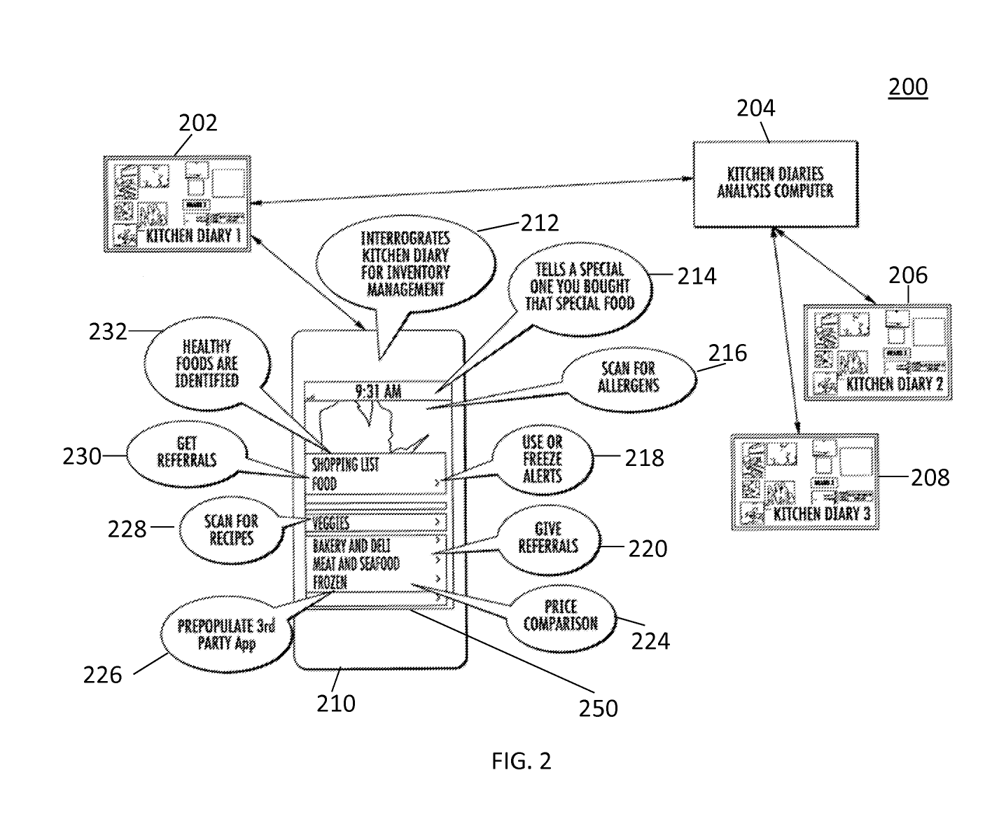

FIG. 2 is a diagram of an example food management system 200. The example food management system 200 illustrated in FIG. 2 includes a number of kitchen diaries 202, 206 and 208 and a kitchen diaries analysis computer 204, which may perform analysis on the various data inputs provided through the kitchen diaries 202, 206 and 208 or on FAMOs stored therein to provide information back to the kitchen diaries 202, 206 and 208, as described in detail above with respect to FIGS. 1A and 1B, for use by the user thereof. Each of the kitchen diaries 202, 206 and 208 may also communicate with an application, such as a personal food assistant, operating on a wireless receive/transmit unit (WRTU) 210, such as a smart phone.

A GUI 250 for an example application running on the WRTU 210 is also illustrated in FIG. 2. The example GUI 250 includes a number of different regions where a user can either engage in various food management activities or in which food-management-related-information may be displayed. The GUI 250 may be used, for example, for interrogating the associated kitchen diary for inventory management (212), for communicating information about a food a user bought to other users (214), for scanning for allergies (216), for allowing a user to control using or freezing of alerts (218), and for giving referrals (220). The GUI 250 may also be used, for example, for price comparison (224), for prepopulating third party applications (226), for scanning for recipes (228), for getting referrals (230), and for identifying healthy foods (232). Some of the regions on the GUI 250 of the WRTU application may the same as, or similar to, regions of the GUI 150 for the kitchen diary. This may be illustrative of the fact that a user may view and interact with the food management system 200 using a number of different devices in a variety of display formats, including, for example, smartphones, tablet personal computers (PCs) and PCs.

An advantage of this standardization of information about food activity is the ability to leverage the experience of specific consumers to help others. Analyzing food activities by a set of consumers who share similar traits or who rate their activities in a similar manner, providing information on food cross-contamination based on recurrences of issue reports, recommendation for new products or recommendations for new recipes.

The skilled artisan will readily appreciate that the methods and systems herein may be implemented with multiple consumers, multiple prospective consumers, and/or multiple registered consumers.

The methods herein may be implemented on myriad types of devices and/or combinations of devices. Combinations of devices may be functionally connected by physical or wireless connections as known in the art. A device, such as a WRTU, may include one or more of an antenna, a processor, a memory device, a communication interface, a data storage device, and a display, which may be a touchscreen display, and the processor may be configured to implement any of the methods described herein. These components may be connected via a system bus in the device and/or via other appropriate interfaces within the device.

The memory device may be, or may include, a device such as a Dynamic Random Access Memory (D-RAM), Static RAM (S-RAM), or other RAM or a flash memory.

The data storage device may be, or may include, a hard disk, a magneto-optical medium, an optical medium such as a CD-ROM, a digital versatile disk (DVDs), or Blu-Ray disc (BD), or other type of device for electronic data storage. The data storage device may store instructions that define the application and/or data that is used by the application.

The communication interface may be, for example, a communications port, a wired transceiver, a wireless transceiver, and/or a network card. The communication interface may be capable of communicating using technologies such as Ethernet, fiber optics, microwave, Digital Subscriber Line (xDSL), Wireless Local Area Network (WLAN) technology, wireless cellular technology, and/or any other appropriate technology.

The touchscreen display may be based on one or more technologies such as resistive touchscreen technology, surface acoustic wave technology, surface capacitive technology, projected capacitive technology, and/or any other appropriate touchscreen technology.

When the touchscreen receives data that indicates user (e.g., a consumer, prospective consumer, or registered consumer) input, the touchscreen may provide data to an application implementing at least a portion of a method herein.

The application may be loaded into the memory device. Although actions are described herein as being performed by the application, this is done for ease of description and it should be understood that these actions are actually performed by the processor (in conjunction with a persistent storage device, network interface, memory, and/or peripheral device interface) in the device, according to instructions defined in the application. The instructions may be stored on a computer readable medium. Alternatively or additionally, the memory device and/or the data storage device in the device may store instructions which, when executed by the processor, cause the processor to perform any feature or any combination of features described above as performed by the application. Alternatively or additionally, the memory device and/or the data storage device in the device may store instructions which, when executed by the processor, cause the processor to perform (in conjunction with the memory device, communication interface, data storage device, and/or the display, which may be a touchscreen display) any feature or any combination of features described above as performed by the application.

The device may be, for example, an Apple iPad, an Apple iPhone, any other smartphone, or any other appropriate computing device. The application may run on an operating system such as iOS, Android, Linux, Windows, and/or any other appropriate operating system.

As used herein, the term “processor” broadly refers to, and is not limited to, a single- or multi-core central processing unit (CPU), a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to, and is not limited to, a register, a cache memory, a ROM, a semiconductor memory device (such as a D-RAM, S-RAM, or other RAM), a magnetic medium, such as a flash memory, a hard disk, a magneto-optical medium, an optical medium such as a CD-ROM, a DVD, a BD, or other type of device for electronic data storage.

The features described herein may also be implemented, mutatis mutandis, on a desktop computer, a laptop computer, a netbook, a cellular phone, a personal digital assistant (PDA), or any other appropriate type of computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Further embodiments herein may be formed by supplementing an embodiment with one or more elements from any one or more other embodiment herein and/or substituting one or more element from one embodiment with one or more element from one or more other embodiments herein.

It is understood, therefore, that this invention is not limited to the particular embodiments disclosed, but is intended to cover all modifications that are within the spirit and scope of the invention as defined by the appended claims; the above description; and/or shown in the attached drawings.

What is claimed is:

1. A computer-implemented method of recommending recipes to a user of a food management system, the method comprising:
identifying a group of recipes from among a plurality of recipes in a database;
receiving a grade selection, from each of a plurality of users of the food management system, for each of the recipes in the identified group;
calculating an average grade for the group of recipes based on the grade selection received from each of the plurality of users of the food management system;
identifying one of the plurality of users of the food management system from whom a grade selection was received that is greater than the average grade for the group of recipes;
correlating the grade selection received from the identified one of the plurality of users for the group of recipes with the grades received from the other users of the plurality users for the same group of recipes;
identifying at least one of the other users whose grades most closely correlate with the grade given to the group of recipes by the identified user; and
providing one or more recipes in the database to the identified one of the plurality of users that the identified one of the plurality of users has not graded based on grades given to the recommended recipe by the identified at least one of the other users.

2. The method of claim 1, wherein the providing includes displaying the one or more recipes on a display.

3. The method of claim 1, further comprising:
receiving at least one piece of consumer-specific information about the consumer, wherein the at least one piece of consumer-specific information includes at least one of a diet restriction, a food restriction, an ingredient restriction, an additive restriction, a diet framework, a diet plan, a food selection restriction, a food preference, cross-contamination information, a budgetary guideline, or a loyalty program, wherein the providing the one or more recipes in the database to the identified one of the plurality of users that the identified one of the plurality of users has not graded is based on the grades given to the recommended recipe by the identified at least one of the other users and the received at least one piece of consumer-specific information.

4. The method of claim 1, wherein the receiving the grade selection includes:
receiving information describing at least one aspect of the recipe, and
converting the information describing the at least one aspect of the recipe to a numerical value.

5. The method of claim 1, wherein the receiving the grade selection further includes displaying a grading scale on a display, the grading scale corresponding to at least one aspect of each of the plurality of recipes.

6. The method of claim 1, wherein the correlating comprises one of standard correlating and distance correlating.

7. The method of claim 1, wherein the average grade is a function of the grade selection and at least one other of at least one consumer rating, a number of referrals, a number of likes, a number of uses, a number of purchases, a proportion of purchases, food restrictions, ingredient restrictions, compliance with religious regulations, organic nature, processing restrictions, brand restrictions and country of origin restrictions.

8. A food management system comprising:
a least one computer, each configured with a kitchen diary, wherein each computer comprises at least a display, a processor, and a transmit/receive element;
a database; and
a kitchen diaries analysis computer comprising a processor configured to:
identify a group of recipes from among a plurality of recipes in the database,
receive a grade selection, from each of a plurality of users of the at least one computer, for each of the recipes in the identified group,
calculate an average grade for the group of recipes based on the grade selection received from each of the plurality of users,
identify one of the plurality of users from whom a grade selection was received that is greater than the average grade for the group of recipes,
correlate the grade selection received from the identified one of the plurality of users for the group of recipes with the grades received from the other users of the plurality of users for the same group of recipes,
identify at least one of the other users whose grades most closely correlate with the grade given to the group of recipes by the identified user, and
provide one or more recipes in the database to the identified one of the plurality of users that the identified one of the plurality of users has not graded based on grades given to the recommended recipe by the identified at least one of the other users.

9. The system of claim 8, wherein the providing comprises:
identifying the one or more recipes,
retrieving the identified one or more recipes from the database, and
transmitting the identified one or more recipes for display on one of the at least one computer.

10. The system of claim 8, wherein the processor of the kitchen diaries analysis computer is further configured to receive at least one piece of consumer-specific information about the consumer, wherein the at least one piece of consumer-specific information includes at least one of a diet restriction, a food restriction, an ingredient restriction, an additive restriction, a diet framework, a diet plan, a food selection restriction, a food preference, cross-contamination information, a budgetary guideline, or a loyalty program, wherein the providing the one or more recipes in the database to the identified one of the plurality of users that the identified one of the plurality of users has not graded is based on the grades given to the recommended recipe by the identified at least one of the other users and the received at least one piece of consumer-specific information.

11. The system of claim 8, wherein the receiving the grade selection includes:
receiving information describing at least one aspect of the recipe, and
converting the information describing the at least one aspect of the recipe to a numerical value.

12. The system of claim 8, wherein the receiving the grade selection further includes transmitting a grading scale to be displayed on the display of the at least one computer, the grading scale corresponding to at least one aspect of each of the plurality of recipes.

13. The system of claim 8, wherein the correlating comprises one of standard correlating and distance correlating.

14. The system of claim 8, wherein the average grade is a function of the grade selection and at least one other of at least one consumer rating, a number of referrals, a number of likes, a number of uses, a number of purchases, a proportion of purchases, food restrictions, ingredient restrictions, compliance with religious regulations, organic nature, processing restrictions, brand restrictions and country of origin restrictions.
